(19) United States
(12) Patent Application Publication
(10) Pub. No.: US 2009/0094144 A1
(43) Pub. Date: Apr. 9, 2009

(54) BUSINESS MODEL OF A BILLING PROCEDURE FOR RENTING MEDICAL EQUIPMENT

(75) Inventors: Sabastian Schmidt, Weisendorf (DE); Jurgen Kampmeier, Erlangen (DE)

Correspondence Address: BRINKS HOFER GILSON & LIONE, P.O. BOX 10395, CHICAGO, IL, 60610, US

(73) Assignee: Siemens Aktiengesellschaft, Munchen (DE)

(21) Appl. No.: 11/869,538

(22) Filed: Oct. 9, 2007

(51) Int. Cl. G06Q 40/00; G06Q 30/00

(52) U.S. Cl. 705/34; 705/35; 705/38

(57) ABSTRACT

A system and method relate to dynamic financial models associated with financing, such as leasing or purchasing, equipment and/or services. The financial models may dynamically update a rate of payment based upon variable conditions. In one aspect, the financial models facilitate the lease of medical equipment. A rental rate for a piece of medical equipment being leased may be adjusted to account for changing conditions. The rental rate may be updated as a function of fluctuating health care insurance re-imbursement rates, fluctuating billing or other medical guidelines, the number and/or type of procedures being performed with medical equipment being leased, interest rates, and/or other factors. The dynamic calculation of the rental rate to reflect actual conditions may reduce financial risk posed to a medical practitioner or facility. Accordingly, a significant barrier of entering a highly specialized market associated with medical equipment and the medical services provided thereby may be alleviated.

### BACKGROUND

The present embodiments relate generally to lease or sales agreements. More particularly, the present embodiments relate to lease and/or sales contracts that reduce investment risk from the point of view of the leasee or buyer.

Conventional types of equipment may cost a rather substantial amount of money. For instance, medical devices, such as medical imaging devices, may be so-called “high ticket” items. Not surprisingly, medical equipment is being increasingly leased or rented, rather than purchased, by medical practitioners and facilities.

However, medical practitioners or facilities may delay or entirely avoid leasing medical equipment due to the actual or perceived associated financial risks. Certain medical practitioners or facilities may have an uncertain number of anticipated uses for specific types of medical equipment and/or only limited financial and personnel resources. As a result, the financial rewards of leasing such equipment may be unascertainable, difficult to accurately define, or appear to be non-existent at the time that the decision of whether to enter into a lease agreement is being made by a potential leasee.

Additionally, any realized financial benefits of leasing or purchasing medical equipment may be affected by changing realities after entering into the lease or purchase agreement. The prospect of changing financial related realities may make potential customers hesitant or unwilling to enter into a conventional financing agreement. Accordingly, with respect to conventional lease and purchase agreements there may be a need for new forms of financing. This may be especially true in the health care field due to the increasing commercialization of medical care and the rising cost pressures.

### BRIEF SUMMARY

A system and method relate to dynamic models of financing, such as lease or purchase financing agreements. A lease or purchase agreement may entail a variable payment rate that fluctuates as a function of one or more variable conditions. In one aspect, a rental rate for a piece of medical equipment being leased to a medical practitioner or facility may be dynamically adjusted to account for one or more current, real-world conditions. The rental rate may be dynamically adjusted according to fluctuating health care insurance re-imbursement rates, changing billing or other medical guidelines, the number and/or type of procedures actually being performed with the piece of medical equipment being leased or purchased, prevailing interest rates, market or medical trends, and/or other factors. The dynamic adjustment of the rental rate may reduce the financial risk that leasing the piece of medical equipment poses to the leasee, such as a medical practitioner or facility. Accordingly, the dynamic rental rate that is variable to reflect current conditions may operate to reduce a significant barrier to entering a market, such as a highly specialized niche market related to advanced medical equipment and the associated medical procedures performed using that advanced medical equipment.

In one embodiment, a method of dynamic financing accounts for one or more variable conditions. The method includes leasing a medical device to a leasee at a rental rate defined as a function of a fluctuating re-imbursement rate paid by a health care insurance provider to the leasee for medical services rendered by the leasee to a patient having medical insurance coverage provided by the health care insurance provider, the fluctuating re-imbursement rate being associated with a medical procedure accomplished using the medical device.

In another embodiment, a method of dynamic financing accounts for one or more variable conditions. The method includes (1) tailoring a financing agreement with a customer to include a dynamic rate of payment, the financing agreement being associated with the customer leasing a medical imaging device at the dynamic rate of payment; (2) updating a variable parameter; (3) updating the dynamic rate of payment, the updated dynamic rate of payment being calculated as a function of the updated variable parameter; and (4) adjusting an amount charged to the customer pursuant to the financing agreement to reflect the updated dynamic rate of payment.

In another embodiment, a data processing system for dynamic financing accounts for one or more variable conditions. The system includes a processing unit that (1) accepts data related to a current state of at least one variable condition pertinent to a dynamic financial agreement with a customer, the dynamic financial agreement being a financing agreement for a piece of medical equipment, (2) calculates an updated payment rate for the dynamic financial agreement using the data related to the current state of the at least one variable condition, and (3) bills the customer an amount based upon the updated payment rate.

In yet another embodiment, a computer-readable medium provides instructions executable on a computer. The instructions direct dynamically altering a payment rate associated with the financing of a piece of medical equipment to account for a fluctuating medical billing guideline and updating a billing to a customer to reflect the dynamically altered payment rate.

Advantages will become more apparent to those skilled in the art from the following description of the preferred embodiments which have been shown and described by way of illustration. As will be realized, the system and method are capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 illustrates an exemplary method of dynamic financing that updates a rate of payment to reflect one or more variable conditions;

FIG. 2 illustrates an exemplary method of dynamic financing for existing medical equipment that updates a rate of payment to reflect one or more variable conditions;

FIG. 3 illustrates an exemplary method of dynamic financing for new medical technologies that updates a rate of payment to reflect one or more variable conditions; and

FIG. 4 illustrates an exemplary data processor configured or adapted to provide the functionality for dynamical financing models that adjust the rate of payment to account for one or more variable conditions.

### DETAILED DESCRIPTION

The embodiments described herein include methods, processes, apparatuses, instructions, systems, or business concepts for dynamic models of financing. The dynamic financing models may involve dynamically adjusting a rate of payment to account for one or more current, real-world conditions. The rate of payment may be associated with a lease, a purchase, or other financing agreement with a customer. The rate of payment that the customer, such as a leasee or a purchaser, is billed may be calculated as a function of one or more variable conditions. For example, a monthly or quarterly bill may be adjusted to reflect variable conditions.

In one embodiment, the dynamic financing model relates to the lease of medical equipment. The rental rate for a medical device being leased may be adjusted for current conditions. The rental rate may be dynamically updated to account for fluctuating health care insurance re-imbursements, varying medical billing guidelines, the number and/or type of procedures performed using the medical equipment being leased or purchased, prevailing interest rates, market conditions, medical trends, the cost to operate and maintain the medical equipment being financed, customer specifications, customer protocols, and/or other factors. The dynamic adjustment of the rental rate may reduce the financial risk that leasing the medical equipment poses to a potential customer. Accordingly, the dynamic adjustment of the rental rate to reflect current conditions may reduce a significant barrier of market entry associated with advanced medical equipment and specialized procedures.

In general, certain types of equipment may be increasingly leased or rented due to the high cost to purchase and maintain such equipment. However, conventional financing models/leasing arrangements may prove to be unfavorable from the end user's perspective. With respect to the medical field in particular, it may become more and more difficult for potential customers (such as a medical practitioner or facility) to enter into a standard long-term payment obligation for a piece of equipment.

These difficulties may stem in part from constant changes in health care insurance, insurance providers' policies, the law, mandatory regulations, market conditions or trends, or other factors. It may not be clear to the potential customer what amount the customer will be re-imbursed in the future by health care insurance providers or a centralized health insurance system for examinations performed with the leased piece of equipment. For instance, re-imbursement rates may change periodically, creating financial uncertainty and associated unwanted risks. “Health care insurance providers” as used herein may include health care insurance providers, centralized health insurance systems, such as insurance systems organized and run by governmental agencies, and other health care insurance related entities, programs, and organizations.

As a result of the financial risk, decisions to lease or purchase medical equipment may be delayed, postponed, or entirely avoided by potential customers. This may be especially true in the case of: (1) expensive medical equipment, such as computed tomography (CT) or magnetic resonance imaging (MRI) equipment; (2) special diagnostic procedures that may be billed only in a specific manner; and (3) where the change in billing is difficult to predict.

The financial uncertainties associated with the lease or purchase of medical equipment also may affect medical equipment manufacturers. From the perspective of the manufacturer, the financial uncertainties and risks posed to potential customers may make it more difficult to introduce new technologies, such as MRI-PET (magnetic resonance imaging-positron emission tomography) equipment. The financial risks may stem from unanswered questions about the re-imbursement amount to be paid to the potential customers by health care insurance providers, or a health insurance system, program or entity, for medical procedures performed by the potential customers using the new technologies and/or equipment.

The present embodiments provide relief for potential customers of the investment risk and reduce overall financial uncertainty. The dynamic financial models as discussed herein for reducing financial risk may involve renting, leasing, paper use, furnishing a piece of equipment for free and receiving payments based upon usage, rent to own, purchase, and other financing arrangements.

As compared to other fields, some special aspects of the health care field may not be properly taken into account with typical financing arrangements, including that (1) the payment for medical services provided by a physician may be defined centrally, such as by a medical billing guideline, and not subject to any free market pricing, (2) the re-imbursement guidelines may be subject to major fluctuations, which increases the investment risk to the physician, medical facility, or other customer, and (3) the re-imbursement guidelines may be essentially transparent. As an example, documents such as Medicare guidelines in the United States, the “Uniform Assessment Scale” (“Einheitlicher Bewertungsmassstab”, EBM resp. “Gebuehrenordnung fuer Aerzte”) guidelines in Germany, or other guidelines may be established and published. Physician fee schedules also may be established and published. Other guidelines or industry standards may be established.

In one aspect, the present embodiments may provide for a piece of medical equipment or software being rented to the service provider in the health field (such as a physician with his own practice, joint practice, etc.). The rent may be oriented to the actual usage situation, prevailing re-imbursement rates, and/or the attainable billing guideline. The rent may be adapted correspondingly dynamically. The rent may be adjusted (1) to reflect the number times the equipment is used and/or (2) every time a billing guideline or re-imbursement rate is changed, such as every three months or other period. As an example, for a breast coil used for MRI exams of the breast, the physician may pay a rent per use that amounts to 20% of the re-imbursement guideline for that examination. Other rental rates may be used.

As a result, the manufacturer may take on most or all of the risk associated with any change in re-imbursement rates or billing guidelines associated with a piece of equipment or specific type of procedure. From the customer's point of view, the investment risk may be substantially reduced or even eliminated.

The financial models discussed herein may involve (1) leasing agreements having an agreed upon minimum rent (floor) and/or maximum rent (ceiling); (2) leasing software, such as self-contained software applications, that are rented and payment is made, or billed, each time the software is started/run/executed; (3) leasing imaging devices (such as MRI or CT scanners); (4) the rental payments for leased devices being made on a per examination, per usage time, or per patient basis; and/or (5) orientation of the rent for a medical technology product to a re-imbursement provided for a procedure performed with the product, such as a re-imbursement provided to the medical facility from a health care insurance provider, health care system, the product manufacturer, or other types of re-imbursements. The re-imbursements may include monies, credits, allowances, exchanges, currency, incentives, discounts, rebates, or other benefits or consideration.

In one embodiment, the re-imbursements may be provided to the medical practitioners or facilities by a government sponsored health insurance system or other program that is compulsory for employees. The re-imbursements may be associated with changes in calculating the bill or booking. The re-imbursements may be associated with Medicare guidelines or other mandatory guidelines.

### I. Exemplary Dynamic Financial Model

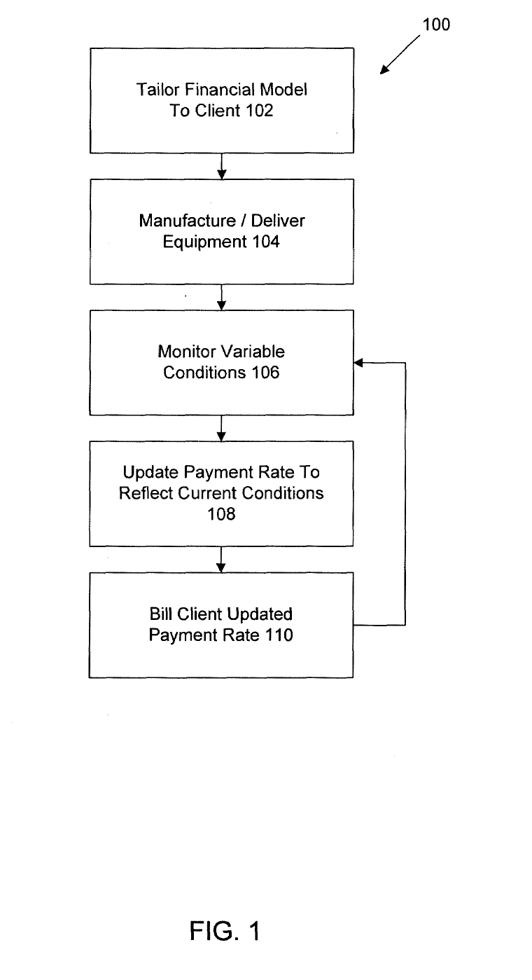

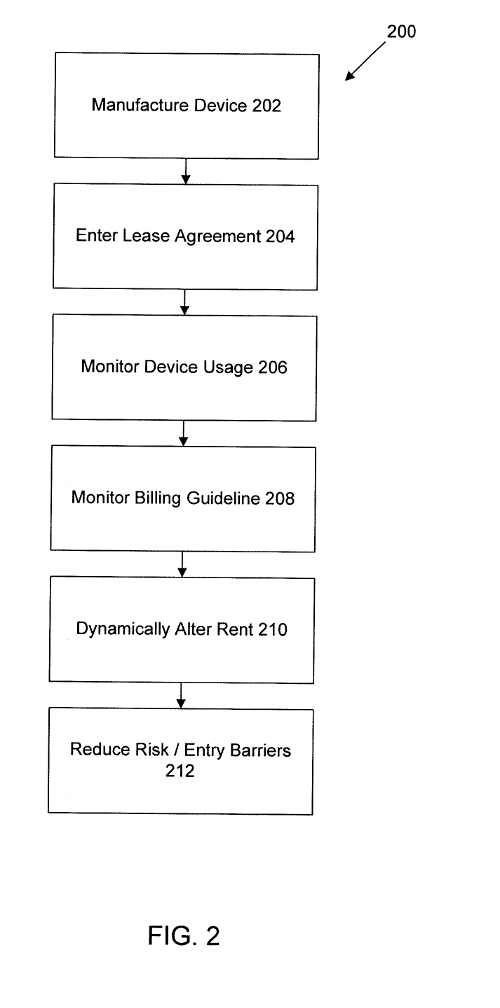

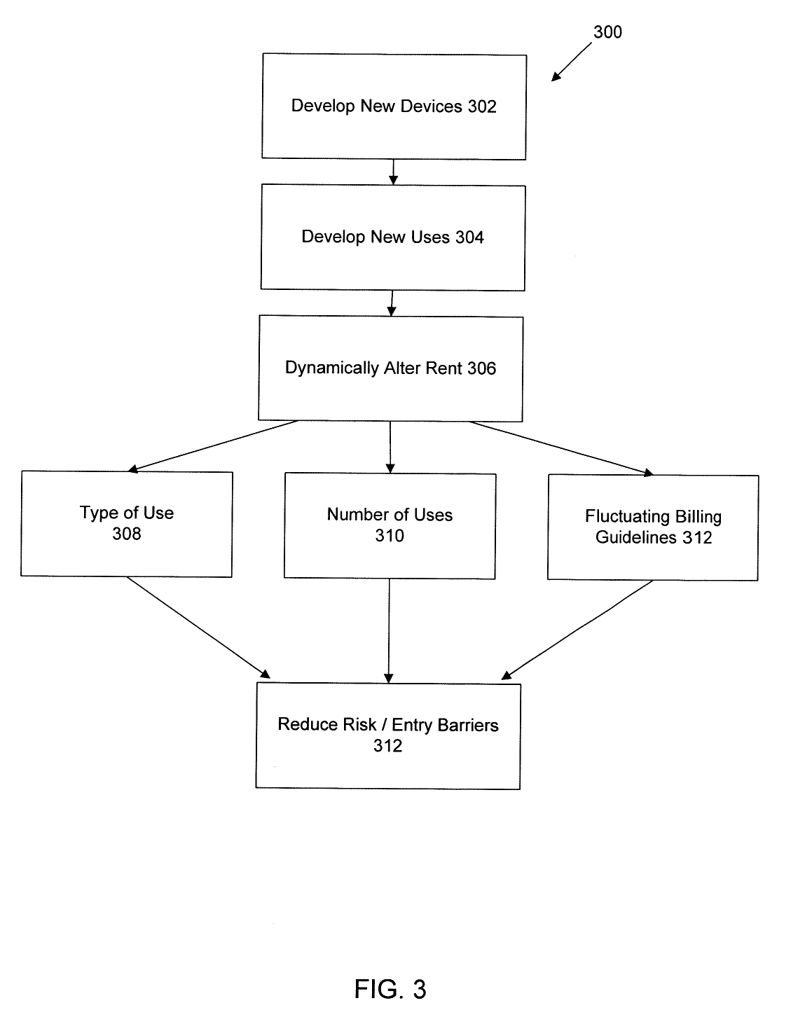

FIG. 1 illustrates an exemplary method of dynamic financing that updates a rate of payment to reflect one or more current conditions 100. The method may involve tailoring the financial model to accommodate the client 102, manufacturing and/or delivering equipment to the client 104, monitoring variable conditions 106, updating a rate of payment to reflect current conditions 108, and billing the client based upon the updated payment rate 110. The method may include additional, fewer, or alternate steps, such as those discussed in relation to FIGS. 2 and 3.

The method 100 may involve tailoring the financial model to accommodate the client 102. Customers may range from individuals or small organizations to large organizations. As a result, each customer's financial situation may yield a different set of customer specific wants and needs. The financial models discussed herein may be adjusted to account for each customer's particular financial situation.

The method 100 may involve manufacturing and/or delivering equipment to the client 104. Equipment may be manufactured by an equipment manufacturer having sufficient expertise in the manufacture and development of such equipment. After manufacture, that equipment may be delivered to the client's location and installed per the client's specifications.

The method 100 may involve monitoring variable conditions 106. The variable conditions may include fluctuating billing or other guidelines, fluctuating re-imbursement amounts, currency exchange rates, the rate of inflation, market conditions, market trends, the times and type of uses of the equipment being financed, economic indexes or other indicators, interest rates, tax rates, and other variable conditions.

The method 100 may involve updating a rate of payment to reflect current conditions 108, such as a current value of the variable conditions mentioned herein. The payment rate may be defined as a fixed part and a variable part. Or the payment rate may be entirely variable. The fixed part may be a floor. The rent may have a ceiling that the sum of the fixed part and the variable part are not to exceed.

The method 100 may involve billing the client based upon the updated payment rate 110. The amount that the client is billed may change based upon the calculation that accounts for one or more of the variable conditions. The client may be billed manually or automatically. For instance, the amount charged to the client may be automatically deducted from a specified account.

The rate of payment may be billed periodically, such as weekly, biweekly, monthly, bimonthly, quarterly, semi-annually, annually or based upon another time period. Alternatively, the rate of payment may include one or more lump sums that may be dynamically adjusted. After billing the client an updated amount 110, the method 100 may loop back to monitoring variable conditions 106 to update the payment rate 108 for the next billing cycle.

### II. Exemplary Dynamic Financing for Existing Technologies

High entry barriers to certain medical services markets may exist due to the high cost items (equipment and software) required to enter. For instance, medical imaging devices may cost one or more millions of dollars. Medical practitioners and facilities may be reluctant to enter these markets due to the high start-up costs. This may be especially true for medical practitioners and facilities with only limited resources, such as those located away from large populaces. This may result in fewer medical options for health care for people living in less populated areas. Accordingly, reducing financial risks to the leasees of medical equipment may provide enhanced health care and a wider range of treatment options to the patients of the leasees.

This may be highly critical with the detection of numerous types of cancer or other illnesses that may be detected via medical imaging devices. Having a CT or MRI performed at a local medical facility immediately or in the near term, rather than waiting weeks or months to have the procedure performed at larger and distant medical facility, may be the difference between curing the disease and death.

Accordingly, FIG. 2 illustrates an exemplary method of dynamic financing for existing medical equipment 200 that updates a rate of payment to reflect one or more variable conditions. The method 200 may include manufacturing a device 202, entering a lease agreement 204, monitoring use of the device 206, monitoring fluctuating billing guidelines/re-imbursement rates 208, dynamically altering the rental rate 210, and reducing the risk and/or barriers to market entry 212. The dynamic financing method may include additional, fewer, or alternate steps, such as those discussed in relation to FIGS. 1 and 3.

The method 200 may include manufacturing a device 202. A manufacturer or other central health organization may design, build, and test a medical device. The design may account for customer specifications, which may be laid out in a dynamic financing agreement.

The method 200 may include entering into the dynamic financing agreement, such as a lease agreement 204. A customer, such as a medical practitioner, facility, or other organization, may enter into the financing agreement with the central health organization. The central health organization may have extensive medical expertise and resources and may tailor the dynamic financial model to accommodate the customer. The dynamic financial agreement may be locally or remotely accessed in a virtual format by the customer via the internet or other communications network. The customer may facilitate the monitoring of current or variable conditions pertinent to the calculation of a dynamic rate of payment. For instance, the customer may remotely enter data via the internet.

Remote customers may remotely access and download virtual representations of the dynamic financial agreement. Actual or estimated savings associated with the dynamic financial model may be calculated and presented to the customer. As a result, health institutions with only limited resources that have yet to acquire certain advanced medical equipment may see the potential effect that a dynamic rental rate may have over a life of a lease arrangement at the time that the financing decision is being made.

The method 200 may include monitoring use of the medical device being financed 206. The use of the medical device may be monitored or tracked in a number of ways. For example, the number of times the medical device is used may be automatically or manually counted and transferred to a processing unit that updates the payment rate. The types of uses of the medical device may be categorized and tabulated. Different types of uses of the medical device may have corresponding different payment rates, billing rates, and/or re-imbursement amounts.

In one aspect, clinical workflows associated with the medical device being financed may be accomplished using one or more interactive software applications installed and used by customer personnel at various customer locations. The clinical workflows and interactive software applications may be directed to medical applications. The clinical workflows and software applications may assist medical personnel located at hospitals and other medical facilities to diagnose and treat patients. The workflows and software applications may support medical imaging techniques and devices.

The method 200 may include monitoring billing guidelines or re-imbursement rates 208. Billing guidelines and/or re-imbursements associated with the use of particular type of medical device may be updated to reflect current values, either manually or automatically. Billing or re-imbursement rates may be changed periodically, such as every quarter.

The method 200 may include dynamically altering the rental rate 210. The rental rate for the equipment being leased may be updated when the value of one or more variable conditions is updated. As a result, the method 200 may include reducing the risk and/or barriers to market entry 212, as discussed herein. For example, when a billing or re-imbursement rate changes, no risk is presented to the medical practitioner or facility, as the rent is automatically changed to reflect the new rate.

### III. Exemplary Dynamic Financing for Developing Technologies

FIG. 3 illustrates another exemplary dynamic lease method 300. The method 300 may include developing a new device 302, developing new uses and procedures for the new device 304, dynamically altering the rental rate for the new device 306, and reducing the risk and/or barriers to market entry 314. The dynamic lease method may include additional, fewer, or alternate steps, such as those discussed in relation to FIGS. 1 and 2.

The method 300 may include developing a new device 302. The manufacturing process may entail polling customers, studying the market, determining wants and needs in the marketplace, finding inefficiencies and other drawbacks of the existing devices, designing, building, and testing the new device, receiving feedback from field regarding the new device, and making further revisions to the new device.

The method 300 may include developing new uses and procedures for the new device 304. With the development of new technology, the full impact of useful employments of that new technology may not be readily apparent until some time after that technology has been deployed. Additionally, new procedures for operation of the new technology and associated devices may require a number of revisions to “get the kinks out.”

The method 300 may include dynamically altering the rental rate for the new device 306. With a new device, estimating a payment rate beforehand may be especially difficult to predict, as a number of unknowns may exist, such as no established billing guidelines or re-imbursement rates and an uncertain level of market acceptance. Therefore, with new devices, the payment rate may be set initially to an arbitrarily low value, such as zero or a small monetary amount, to accommodate the customer. As discussed elsewhere herein, dynamically altering the rental rate may account for the type of use(s) of the new device 308, the number of uses of the new device 310, fluctuating billing guidelines or re-imbursement rates associated with new device 312 (once established), and other factors.

The method 300 may include reducing the risk and/or barriers to market entry 314. The financial models discussed herein may provide advantages to the customer (such as an individual medical facility or physician). For example, the customer may realize lower or no investment risk associated with changing re-imbursement guidelines or other health insurance system fluctuations. The restrictions and restraints faced by the customer with the purchase of equipment may be substantially overcome. As a result of the financial models, a potential customer's hesitation with respect to entering into a financing agreement may be alleviated.

The financial models discussed herein also may provide advantages to the manufacturer, such as easier sales of the corresponding products or services. This may be especially true for new products, where the level of the re-imbursement rate to be provided by the health care insurance providers, systems, and/or organizations have yet to be conclusively determined or if it remains uncertain if any re-imbursement at all will be available.

The financial risks associated with new technology also may be reduced. With pre-existing medical procedures a re-imbursement may already be established. For instance, the medical facility may be re-imbursed a certain amount, such as a $100, for every breast exam performed. However, with new technology, such as MR PET technology, (1) the use and (2) profitability may not be clear. Therefore, reducing the financial risks with the use of such new technology will facilitate the spread and acceptance of that technology in the marketplace, which in turn, may result in an enhanced overall range of medical services and health care available to the public.

### IV. Exemplary Data Processing System

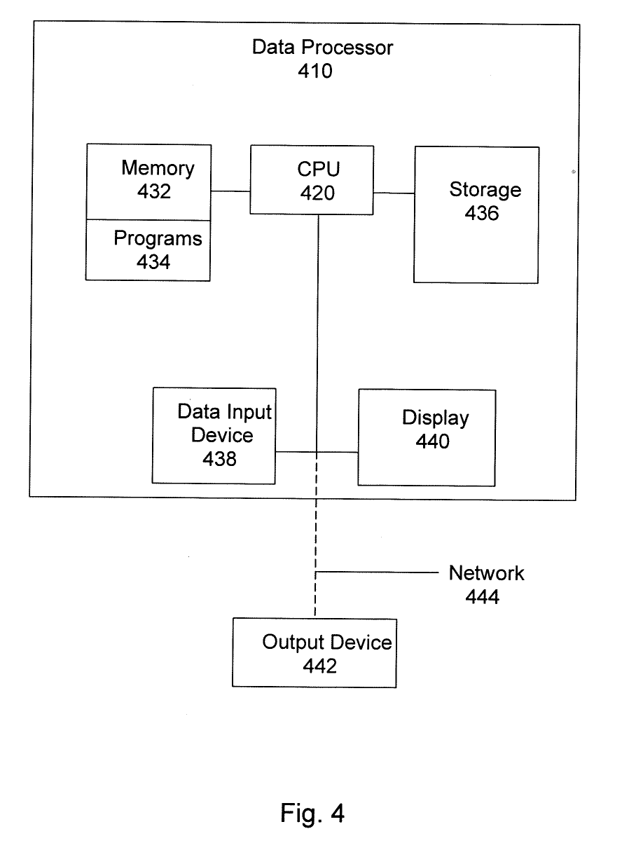

FIG. 4 illustrates an exemplary data processor 410 configured or adapted to provide the functionality for dynamically altering a rate of payment for financed equipment, including calculating an updated rental rate for medical equipment. The data processor 410 may be located at a central location, such as a location associated with a leasor or leasee of medical equipment. The data processor may include a central processing unit (CPU) 420, a memory 432, a storage device 436, a data input device 438, and a display 440. The processor 410 also may have an external output device 442, which may be a display, a monitor, a printer or a communications port. The processor 410 may be a personal computer, work station, PACS station, or other medical imaging system. The processor 410 may be interconnected to a network 444, such as an intranet, the Internet, or an intranet connected to the Internet. The processor 410 may be interconnected to a customer system or a remote location via the network 444. The data processor 410 is provided for descriptive purposes and is not intended to limit the scope of the present system. The processor may have additional, fewer, or alternate components.

A program 434 may reside on the memory 432 and include one or more sequences of executable code or coded instructions that are executed by the CPU 420. The program 434 may be loaded into the memory 432 from the storage device 436. The CPU 420 may execute one or more sequences of instructions of the program 434 to process data. Data may be input to the data processor 410 with the data input device 438 and/or received from the network 444 or customer system. The program 434 may interface the data input device 438 and/or the network 444 or customer system for the input of data. Data processed by the data processor 410 may be provided as an output to the display 440, the external output device 442, the network 444, the customer system, and/or stored in a database.

The program 434 and other data may be stored on or read from machine-readable medium, including secondary storage devices such as hard disks, floppy disks, CD-ROMS, and DVDs; electromagnetic signals; or other forms of machine readable medium, either currently known or later developed. The program 434, memory 432, and other data may comprise and store a database having one or more lease, purchase, or other financial agreements. Electronic versions of the financial agreements may be organized such that they are searchable and retrievable via a search engine operating over a network, such as the network 444.

In one embodiment, the data processor 410 may be operable to modify rental rate associated with the lease of medical equipment. The data processor 410 may receive information regarding a number of variable conditions, such as the variable conditions discussed herein. The data processor 410 may adjust the rental rate based upon the variable conditions such that the current values of the variable conditions are reflected in the updated rental rate. The updated rental rate may be stored within a database or other memory unit. The current and/or otherwise variable conditions data may be received by the data processor 410 from the data input device 438, the network 444, or another input device. After which, the data processor 410 may revise the rental rate to create a modified rental rate that may be stored in the memory 432, the storage device 436, or other storage unit.

The program or other software associated with the data processor system may include instructions that (1) accept data related to a current state of at least one variable condition pertinent to a dynamic financial agreement with a customer, the dynamic financial agreement being a financing agreement for a piece of medical or other equipment, (2) calculate an updated payment rate for the dynamic financial agreement using the data related to the current state of the at least one variable condition, and (3) bill the customer an amount based upon the updated payment rate.

Variable condition data may relate to fluctuating billings rates, fluctuating re-imbursement rates, such as re-imbursement rates associated with the use of or procedures performed by the medical equipment being leased, the number and/or type of uses of the medical equipment being leased, and/or other factors. For instance, variable condition data may be based upon customer specific data and/or customer specifications related to medical equipment and clinical workflows, such as customer resource restrictions, preferences, or characteristics. Variable condition data may be received from a customer location by the data processor 410 via the data input device 438, the network 444, the customer system, or another input device. The data processor 410 may modify a rental rate using the variable condition data. The original and modified rental rates and associate information may be transferred to a customer or leasee location via the network 444, output device 442, or other manner.

### V. Exemplary Financial Models and Lease Agreements

In the aspect that the equipment leased is related to the medical field, the customer locations may be hospitals, clinics, individual health care providers or physicians, or other medical facilities. The customer personnel may include doctors, nurses, and other medical personnel. The medical equipment leased may assist the medical personnel with the diagnosis of medical conditions and the treatment of patients.

The medical equipment leased may relate to processing images illustrating an enhanced region of interest within a patient. For example, various types of contrast medium may be administered to a medical patient. The contrast mediums enhance the scans acquired by scanning a patient or images of the patient, the scans and images may be recorded by an external recording device as enhancement data. The contrast medium typically travels through a portion of the body, such as in the blood stream, and reaches an area that medical personnel are interested in analyzing. While the contrast medium is traveling through or collected within a region of interest, a series of scans or images of the region of interest of the patient may be recorded for processing and display by the software applications. The enhanced region of interest may show the brain, the abdomen, the heart, the liver, a lung, a breast, the head, a limb or any other body area.

The expected enhancement data may be generated for one or more specific type of image processes that are used to produce the images or scans of the patient. In general, the types of imaging processes performed by the medical equipment being leased to produce patient images or scans of internal regions of interest include radiography, angioplasty, computerized tomography, ultrasound and magnetic resonance imaging (MRI). Additional types of imaging processes may performed by the medical equipment being leased, such as perfusion and diffusion weighted MRI, cardiac computed tomography, computerized axial tomographic scan, electron-beam computed tomography, radionuclide imaging, radionuclide angiography, single photon emission computed tomography (SPECT), cardiac positron emission tomography (PET), digital cardiac angiography (DSA), and digital subtraction angiography (DSA). In one aspect, the equipment leased is a MRI related device, such as a brain PET device. Alternate imaging processes may be used.

Each piece or type of medical equipment may have customer protocols or other customer specific data dependent upon the type of imaging process(es) or imaging processing device. The customer protocols or other customer specific data may comprise the one or more of the variable conditions as discussed herein used to adjust the payment rate associated with a financing agreement.

The customer protocols may include all of the settings for the operating machines and medical imaging modules and subroutines associated with the software application in order to generate medical image data. The settings may be manufacturer, supplier, or distributor specific or may be customized by the customer. For example, the customer protocols may account for the type of machine used by the customer and/or comprise settings for magnetic resonance imaging devices, computer tomography devices, and other imaging processes devices, including, but not limited to, devices pertaining to the imaging processes mentioned directly above.

The customer protocols also may account for the respective image type. The customer protocols may account for images generated by angiographic, orthopedic, or other imaging processes, including, but not limited to, the imaging processes mentioned directly above. Additionally, the customer protocols may account for the location of the region of interest displayed in the images, such as the cranium, the brain, the abdomen, the heart, the liver, a lung, a breast, the head, a limb, the torso, or any other body area.

Additionally, the customer specific data may pertain to a customized user interface of the previous version of the software application. Each medical software application may use customer specific data related to displaying customized windows or text boxes that present messages to be displayed and accept directions from a user, such as what information is to be analyzed. The customer specific data may pertain to additional, fewer, or alternate user specific settings and customizations.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A method of dynamic financing that accounts for one or more variable conditions, the method comprising:
leasing a medical device to a leasee at a rental rate defined as a function of a fluctuating re-imbursement rate paid by a health care insurance provider to the leasee for medical services rendered by the leasee to a patient having medical insurance coverage provided by the health care insurance provider, the fluctuating re-imbursement rate being associated with a medical procedure accomplished using the medical device.

2. The method of claim 1, wherein the medical device is a computed tomography or magnetic resonance imaging device.

3. The method of claim 1, wherein the rental rate is further defined as a function of medical billing guidelines.

4. The method of claim 1, wherein the rental rate is further defined as a function of the number of and/or type of medical procedures accomplished using the medical device.

5. The method of claim 1, the method comprising developing guidelines for accomplishing a medical procedure to be accomplished using the medical device, the medical device being associated with newly developed technology, wherein an initial re-imbursement rate to be provided by the health care insurance provided is yet to be ascertained and an initial value of the rental rate is set at an arbitrarily low amount to reduce the financial risk to the leasee.

6. A method of dynamic financing that accounts for one or more variable conditions, the method comprising:
(1) tailoring a financing agreement with a customer to include a dynamic rate of payment, the financing agreement being associated with the customer leasing a medical imaging device at the dynamic rate of payment;
(2) updating a variable parameter;
(3) updating the dynamic rate of payment, the updated dynamic rate of payment being calculated as a function of the updated variable parameter; and
(4) adjusting an amount charged to the customer pursuant to the financing agreement to reflect the updated dynamic rate of payment.

7. The method of claim 6, wherein the variable parameter is a re-imbursement amount paid by a health insurance provider to the customer for medical services rendered by the customer to a patient having medical insurance coverage provided by the health insurance provider, the medical services rendered being performed by the customer on the patient using the medical imaging device.

8. The method of claim 6, wherein the variable parameter is a number of medical procedures performed by the customer using the medical imaging device.

9. The method of claim 6, wherein the variable parameter is associated with a type of usage of the medical imaging device performed by the customer.

10. The method of claim 6, wherein the variable parameter is a number of times a software application associated with the medical imaging device is executed by the customer while providing medical services.

11. The method of claim 6, wherein the variable parameter is based upon a medical billing guideline.

12. The method of claim 6, wherein the medical imaging device is a positron emission tomography imaging device.

13. A data processing system for dynamic financing that accounts for one or more variable conditions, the system comprising:
a processing unit that (1) accepts data related to a current state of at least one variable condition pertinent to a dynamic financial agreement with a customer, the dynamic financial agreement being a financing agreement for a piece of medical equipment, (2) calculates an updated payment rate for the dynamic financial agreement using the data related to the current state of the at least one variable condition, and (3) bills the customer an amount based upon the updated payment rate.

14. The system of claim 13, wherein the financing agreement is a lease agreement and the payment rate is a rental rate.

15. The system of claim 13, wherein the at least one variable condition is a fluctuating re-imbursement rate associated with the use of the piece of medical equipment paid by a health care institution to the customer.

16. The system of claim 13, wherein the data accepted indicates a number of times a software application associated with operating the piece of medical equipment is executed by the customer.

17. The system of claim 13, wherein the piece of medical equipment is a computed tomography or magnetic resonance imaging device.

18. A computer-readable medium having instructions executable on a computer stored thereon, the instructions comprising:
dynamically altering a payment rate associated with the financing of a piece of medical equipment to account for a fluctuating medical billing guideline; and
updating a billing to a customer to reflect the dynamically altered payment rate.

19. The computer-readable medium of claim 18, wherein the payment rate is a rental rate associated with leasing the piece of medical equipment.

20. The computer-readable medium of claim 18, wherein the payment rate is further dynamically altered to account for a re-imbursement rate provided by a health care institution to the customer based upon medical services performed using the piece of medical equipment.

21. The computer-readable medium of claim 20, wherein the piece of medical equipment is a medical imaging device.
